(19) United States
(12) Patent Application Publication
(10) Pub. No.: US 2019/0163723 A1
(43) Pub. Date: May 30, 2019

(54) DIGITAL WRITING PLATFORM

(71) Applicant: ALINA M. TRUEBA, MIAMI, FL (US)

(72) Inventor: ALINA M. TRUEBA, MIAMI, FL (US)

(73) Assignee: KANGOWRITE, LLC, MIAMI, FL (US)

(21) Appl. No.: 16/202,847

(22) Filed: Nov. 28, 2018

Related U.S. Application Data
(60) Provisional application No. 62/591,622, filed on Nov. 28, 2017.

(51) Int. Cl. G06F 17/21; G06F 17/24; G06F 16/93; G06F 16/906; G06F 16/904; G06F 3/0481; G06F 3/0486; G06Q 10/10

(52) U.S. Cl. CPC G06F 17/211; G06F 17/241; G06F 16/93; G06Q 10/103; G06F 16/904; G06F 3/04812; G06F 3/0486; G06F 16/906

(57) ABSTRACT

A computer-implemented method for assisting a writer in organizing and writing a paper with citations includes providing a graphical user interface through which the writer interacts with a plurality of modules configured to generate the paper with automatically applied citations.

### CROSS-REFERENCE TO RELATED APPLICATIONS

This application is a non-provisional of, and claims priority to, U.S. Application Ser. No. 62/591622, filed on Nov. 28, 2017; which is incorporated by reference herein in its entirety.

### FIELD OF THE INVENTION

The present invention generally relates to a digital writing platform, and more specifically relates to a digital writing platform for planning, organizing, and writing a document with citations.

### BACKGROUND OF THE INVENTION

When tasked with writing a document, such as a research paper, one of the most difficult aspects of the assignment is simply knowing where to begin. This is a common source of anxiety for writers of all abilities. Additionally, many writers find the citations and formatting standards of the various documentation styles to be a challenge. Organizing the research and data is a struggle. Submission deadlines are also a cause of anxiety. When performing the research, the sheer volume of information on the Web often leads writers off-topic, wasting valuable time and energy.

Writers can easily find guidance on the correct use of citations, but there is no comprehensive tool to assist a writer in the organizing of the different aspects of a writing project.

### SUMMARY OF THE INVENTION

Briefly, according to an embodiment, a computer-implemented method assists a writer in organizing and writing a paper with correctly formatted citations. The computer-implemented method includes a step of providing a graphical user interface through which the writer interacts with modules configured to generate a paper with automatically generated citations. The modules include, but are not limited to: a “project setting” module, a “planning” module, a “research” module, a “thesis” module, an “organize” module, and a “draft paper” module.

According to another embodiment, a computer-implemented system assists a writer with organizing and writing a paper with citations. The computer-implemented system includes, but is not limited to: a processor device; a memory; and a graphical user interface through which the writer interacts with modules configured to generate the paper with automatically generated citations. The modules include, but are not limited to: a “project setting” module, a “planning” module, a “research” module, a “thesis” module, an “organize” module, and a “draft paper” module.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is an operational flow diagram of an exemplary digital learning process, according to an embodiment;

FIG. 2 shows an exemplary login screen, according to an embodiment;

FIG. 3 shows an exemplary user interface featuring a dashboard, according to an embodiment;

FIG. 4 shows an exemplary user interface for entering project parameters, according to an embodiment;

FIG. 5 shows an exemplary planning screen, according to an embodiment;

FIG. 6 shows an exemplary source selection screen, according to an embodiment;

FIG. 7 shows an exemplary source list, according to an embodiment;

FIG. 8 shows a detailed source selection screen, according to an embodiment;

FIG. 9 shows an exemplary detailed source selection screen, according to an embodiment;

FIG. 10 shows an exemplary content card screen, according to an embodiment;

FIG. 11 shows an exemplary screen showing a list of content cards, including sorting capabilities, according to an embodiment;

FIG. 12 shows an exemplary screen for adding new idea cards, according to an embodiment;

FIG. 13 shows an exemplary thesis screen, according to an embodiment;

FIG. 14 shows an exemplary organization board screen, according to an embodiment;

FIG. 15 shows an exemplary organization board screen with a zoom feature, according to an embodiment;

FIG. 16 shows a final draft screen, according to an embodiment;

FIG. 17 shows an example of a digital source card, according to an embodiment;

FIG. 18 shows an example of a screen for selecting a type of outline, according to an embodiment;

FIG. 19 shows an example of a topic selection screen, according to an embodiment;

FIG. 20 shows an example of a screen for assigning a color identifier to a topic, according to an embodiment;

FIG. 21 shows an example of a screen for adding notes, according to an embodiment;

FIG. 22 shows an example of the different options provided for sharing, according to an embodiment;

FIG. 23 shows an example of a screen for viewing the selected topics, according to an embodiment;

FIG. 24 shows an example of a screen showing how the color-coded topics are placed into the relevant sections of the outline, according to an embodiment; FIG. 25 shows an example of a screen presenting a preview of the completed document for editing, according to an embodiment;

FIG. 26 shows an example screen with a checklist for completion of the project, according to an embodiment;

FIG. 27 shows an example screen presenting the completed document with options for saving/printing/sharing, according to an embodiment;

FIG. 28 is a simplified block diagram showing components of an exemplary system in which embodiments of the invention can be implemented; and

FIG. 29 shows a functional block diagram depicting how the various components of an exemplary system in which embodiments of the invention can be implemented are functionally and structurally interconnected.

While the invention as claimed can be modified into alternative forms, specific embodiments thereof are shown by way of example in the drawings and will herein be described in detail It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Non-Limiting Definitions

As used in this paper, the term “source card” refers to a digital file containing the information for any potential source (reference) to be cited in a paper (also called a bibliography).

The term “content card” refers to a digital file containing content derived from a specific source.

The term “transition card” refers to a digital file containing the writer's own observations, arguments, interpretations, and/or reflections.

The term “research card” or “research deck” refers to any of the “content,” “source,” or “transition” cards.

The term “dashboard” refers to a navigable graphical user interface that organizes and presents information to a user in distinct sections of the screen.

Writing/Research Tool

The following discussion discloses a computer program product in the form of a writing/research platform that provides a novel, systematic approach to writing and research, integrated with project management features. The writing/research platform incorporates a writing/research tool that can be browser-based or offered as a mobile application. While the examples and illustrations provided below are directed to an academic writing project such as a term paper, research paper, or dissertation, the writing/research tool can be advantageously implemented to support the writing of, for example, legal documents, grants, medical papers, and the like.

The writing/research tool offers a simple, easy-to-follow six-step process for collecting, tagging, and organizing a writer's submissions via an easy-to-use graphical user interface such as a dashboard. The dashboard offers alerts, settings, and a help guide. This is the starting point for a paper. It can also be where the user views existing projects in corresponding folders. Clear instructions and examples are provided if desired, without overwhelming the writer with too much information, as in current writing tutorials. The examples and instructions are provided in the form of text, audio, visual, or a combination thereof. A simple icon or button feature provides access to the examples and instructions. For example, selection of an “i” in a circle is a known GUI (graphical user interface) for accessing information.

The inputs to the process are the research paper sources (bibliography), topics, and content. The writer provides the input as prompted by the user interface. The output is an editable draft of the paper, complete with automatically applied citations. The writing/research tool guides a writer through a series of easy-to-follow steps to generate a high-quality paper with correctly-formatted attributions. The process lets the writer select his/her own organizational style and then incorporates that style in a phased process that breaks down a potentially overwhelming assignment into a step-by-step build of a document, complete with correctly-formatted citations.

The computer implemented method disclosed herein, and implemented via the computer program product described, takes various data inputs provided by the user, transforms that data, creates data structures based upon that data, and generates an output to the user wherein the input data has been transformed Through the embodiments of the invention described and disclosed herein, data structures are created and transformed in a way that provides a technical improvement to the computer's functionality.

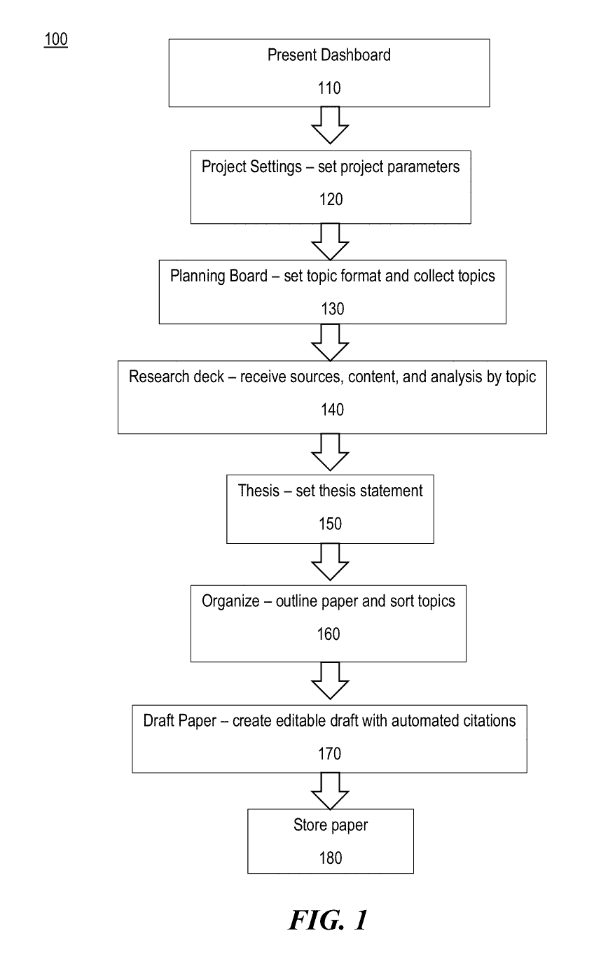

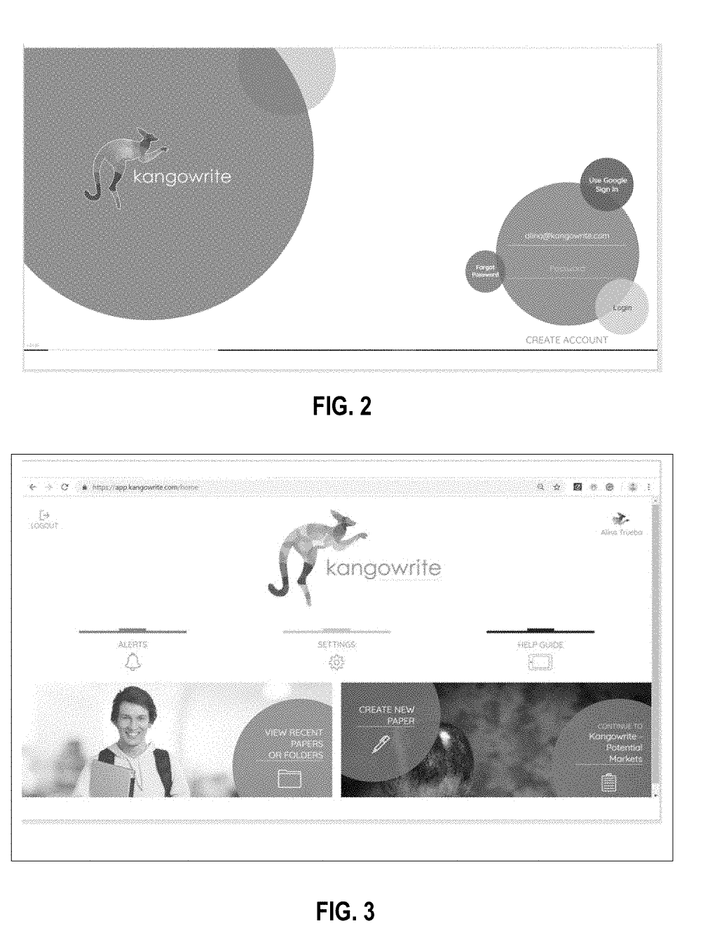

Referring now to the drawings in general and to FIG. 1 in particular, there is shown a high-level operational flow diagram of a method implemented on a computer by the writing/research tool, according to an embodiment. In step 110, after an initial sign-in and verification of credentials provided by the writer (see FIG. 2), the writing/research tool presents a graphical user interface such as the dashboard shown in FIG. 3. After the writer has signed in and his/her credentials have been verified, two options are provided: create a new paper or continue with a previous project. Projects are stored in digital folders. The method, based upon the user inputs received, issues instructions for the processor to access the memory storage medium and create a new data structure for the user/project, or accesses a previously created data structure (as for a previously saved project).

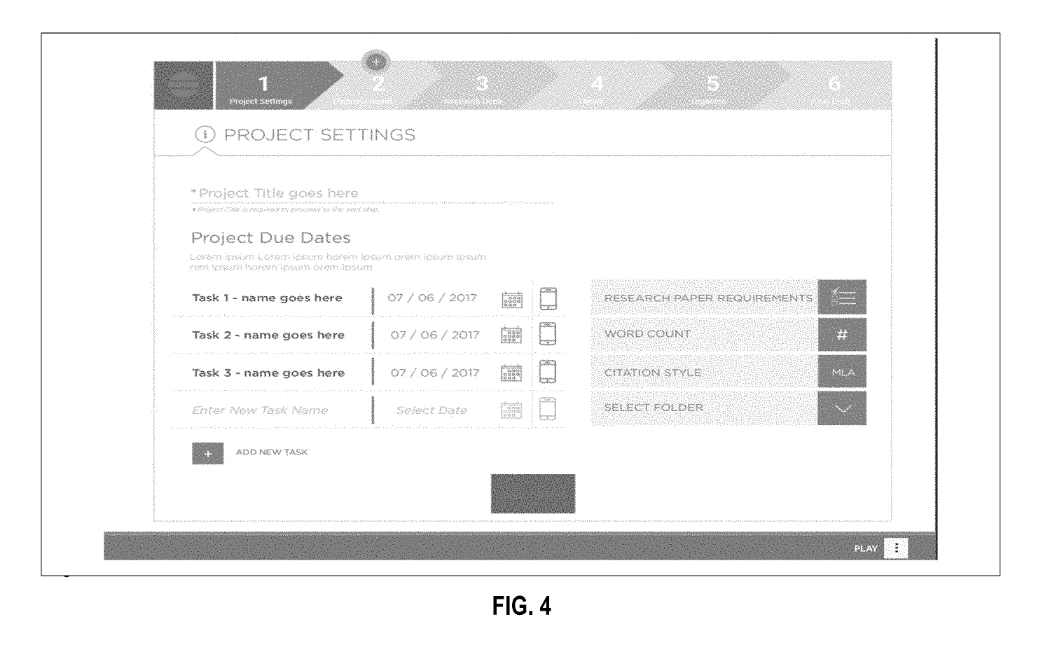

In step 120, the project parameters are set. These can include, inter alia, the project title, project due dates, word count, citation styles, and the minimum number and types of sources, or references, required. FIG. 4 shows an example of a screen for entering project due dates. The citation style can be selected from sources such as the MLA Formatting and Style Guide, the Chicago Manual of Style, and others. For some embodiments, an optional protocol selection can be made to tie the parameters to a specific standard, such as an educational standard, medical protocol, legal standard, or organizational standard.

The writer is also provided with the option of selecting a folder for storing the writing project. One userid can be associated with multiple folders so that a writer can easily keep track of and store multiple writing projects. At a minimum, the writer is required to initially enter a title. The other project parameters can be entered in a subsequent step. In one embodiment, the different steps or phases of the writing/research tool as captioned at the top of FIG. 4 are not necessarily restricted to a sequential implementation. The writer is able to toggle back and forth among the various steps. For example, once the title of the project is provided, the writer is able to navigate directly to the Thesis module and provide the thesis before providing the research cards. In another embodiment, however, the phases can be locked such that successful completion of one phase is required before proceeding to the next phase. The latter embodiment may be favored for instructional use.

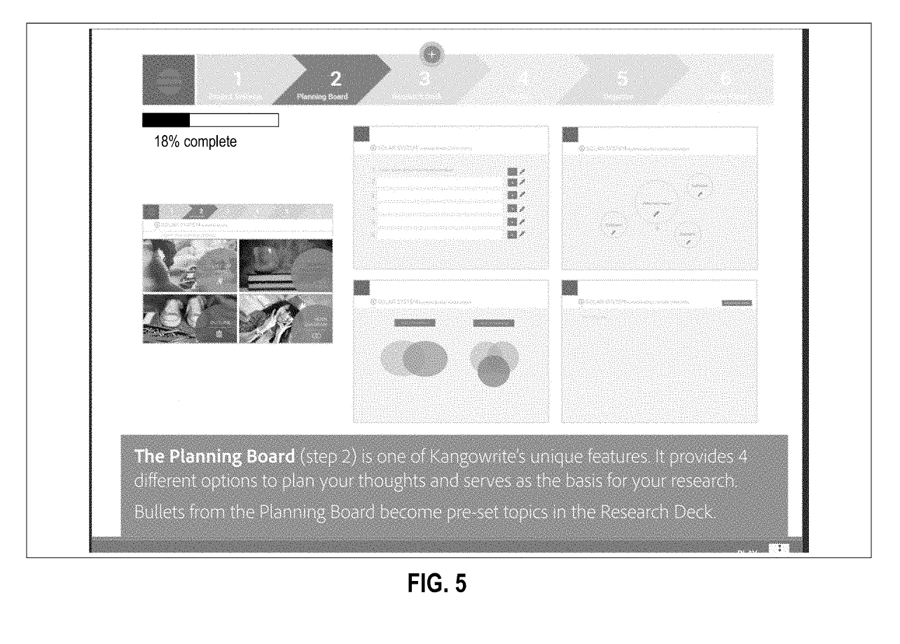

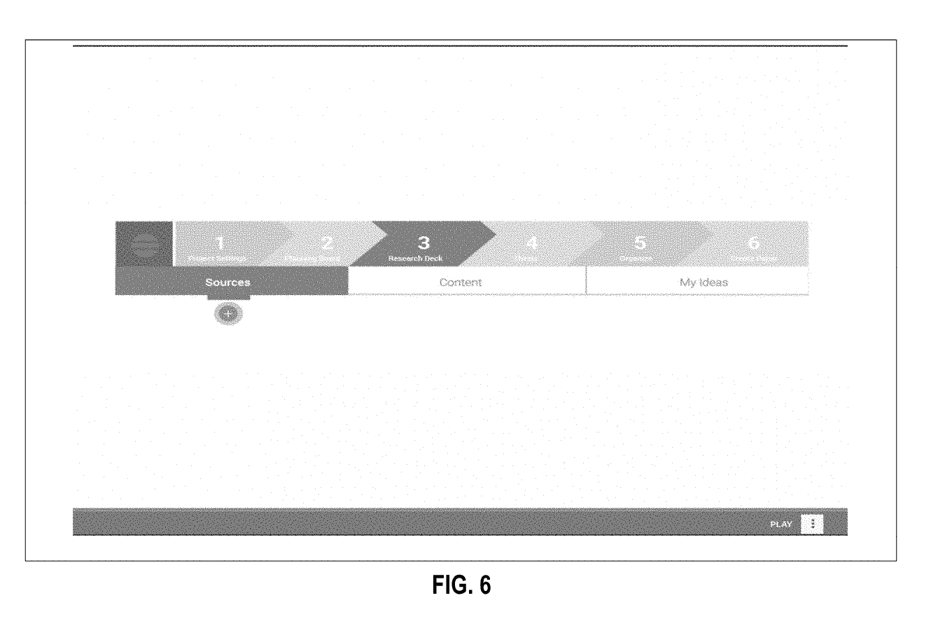

In step 130, the dashboard presents multiple user-selectable project planning formats, such as list style (bulleted list), graphic organizer, Venn diagram, and free-form text. The exemplary planning board shown in FIG. 5 provides a non-limiting example of four different formats for keeping track of project topics and to use as the basis for research. For example, bulleted or bubbled points become pre-set topics to keep writers on track. Next, in step 140, the research deck collects all of the required research cards. FIGS. 6 through 12 are also part of the research deck.

In step 150, the thesis module prompts the writer to provide a thesis statement. In step 160, the Organize Module guides the writer to plan and organize his/her paper through outlining and sorting functions using the topics provided in the previous steps.

In step 170, the Draft Paper Module generates an editable draft of the research paper with automatically applied in-text citations in the appropriate citation style, with the content generated in the Research Deck Module, according to the outline as provided in the Organize Module. The editable draft is stored in step 180. The writer can retrieve the stored draft and make revisions, if necessary.

The main steps to the process are tied to modules that track the above project steps: 1) Project Settings Module; 2) Planning Board Module; 3) Research Deck Module; 4) Thesis Module; 5) Organize Module; and 6) Draft Paper Module. In one embodiment, the modules are implemented as separate and distinct physical or logical components. In another embodiment, the functionality of one module can be shared across modules such that two or more modules are integrated in one physical or logical component.

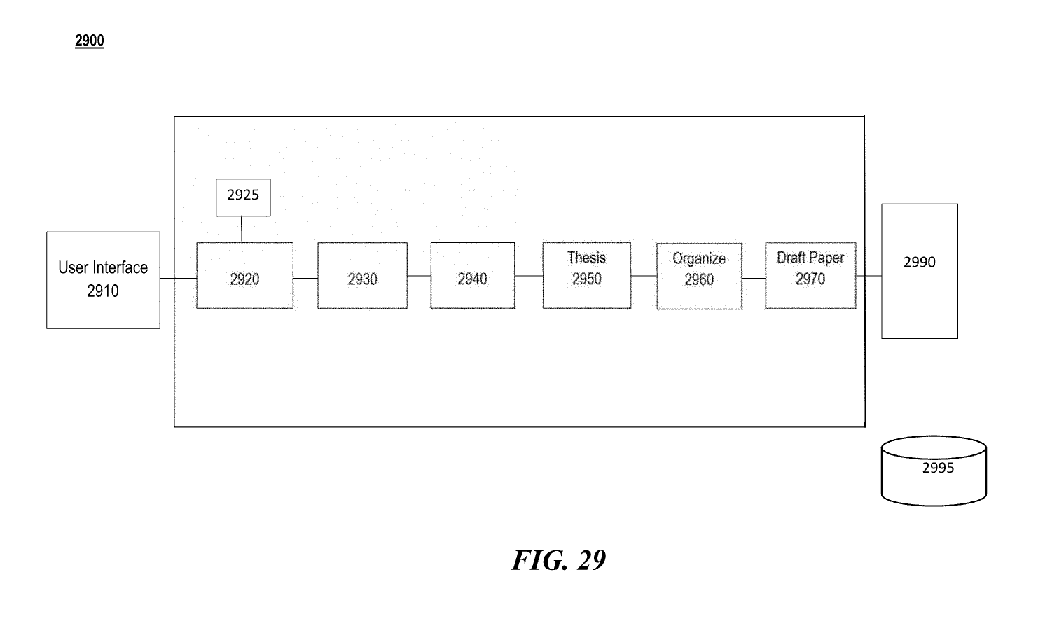

Referring now to FIG. 29, there is shown a functional block diagram 2900 of the components of the writing tool The writer interacts with the writing tool through a user interface 2910, such as the dashboard depicted in FIG. 3. Through the user interface 2910, the writer is guided through the writing process in phases and prompted to enter content and select parameters that format and transform the user-supplied content before advancing to the next phase, or module. Each module generates a data structure that is configured based upon user inputs. In the Project Settings Module 2920 the writer selects various parameters to apply to the content. For example, the writer selects a documentation style, such as, for example, MLA style. The citation parameters are stored in a data store 2925 and updated, as needed. The Project Settings Module 2920 then sets the citation format to use for the paper. Once set in this module, the citation style is applied throughout. The writer can return to the Project Settings Module 2920 to change citation styles.

After setting the parameters, the writer is prompted to input topics and select a planning style in the Planning Board Module 2930. The output from this module is a data structure with color-coded topics, arranged according to the user-selected planning style. The color-coding is applied throughout the writing process. Next, the writer is prompted to input the sources and content in the Research Module 2940. Because the citation style has been pre-set in the Project Settings Module 2920, the references supplied by the user (by free-form input or menu selection) are automatically formatted according to the selected citation style. The output from the Research Module 2940 is a data structure with formatted content and references. The Thesis Module 2950 receives as input the writer's thesis statement. This can be entered as free-form text or selected from the topics introduced in the Planning Board Module 2930.

The Organize Module 2960 aggregates the data structures generated from the previous modules and renders an outline of the color-coded topics. The writer is able to then re-arrange the various sections of the paper. The Draft Paper Module 2970 receives as input the outline from the Organize Module 2960 and fills in the content and source citations produced by the Research Module 2940, producing an editable draft of the research paper, which is then stored. The “Draft Paper” module 2970 accesses the data structures of the other modules, retrieving the data and instructions from those data structures, to transform the data and generate a desired output that has been tailored by the inputs of each module. The generated document is stored in a data store 2995.

Project Settings Module 2920

Referring now to FIG. 4 there is shown an exemplary screen for entering project parameters, such as due dates. Note that in this example, the only required field is the Title of the writing project. Once the Title is entered, the writer can advance to the next module. The remaining project parameters such as due dates and document restrictions (word count, font, margins, citation style, etc.) can be entered at a later time. Entering project parameters activates the tracking system which remains in place throughout the process, across modules. The tracking system applies the paper requirements to the sources, content cards, and My Idea cards, keeping track of parameters such as word count. The tracking system also selects the citation style that will be programmed to generate the citations.

In this screen, the writer can select and name a new folder for storing the project. Note that the writing/research platform can include a shared data structure that functions as a global data repository, thereby allowing a writer to access data, such as digital files, from one project for use in another project, such that data that is associated with one project (folder) can be accessed for use in another project (folder). When implementing a collaborative feature, the global data can be shared across writers and/or devices.

Recognizing that keeping track of project due dates can be a daunting task, the writing/research tool features an easy-to-use calendar function allowing the writer to indicate when/how to receive automatic reminders of upcoming task deadlines (for example, email or text). For example, a writer can select to receive automatic text reminders on his/her mobile device.

Planning Board Module 2930

FIG. 5 shows an exemplary screen depicting four different styles for topic organization. Because people respond differently to different organizational formats, the writing/research tool offers a selection of styles for keeping track of topics as part of the project management functionality. For example, some people are visual learners and respond better to colorful graphical images such as Venn diagrams while others prefer a bulleted list. The example of FIG. 5 shows four different styles: bulleted list; graphic organizer; Venn diagram; and free-form text. One with knowledge in the art will appreciate that this list is not comprehensive and that other styles not depicted here can be provided according to the type of project. Although depicted in black and white here, the graphical images use color for visual appeal, engagement, and identification.

Once the style is selected, the writer adds the main topic and sub-topics within the selected style. Each topic is assigned a color and this color-coding is maintained throughout the project. FIG. 5 also shows an optional progress bar as a visual cue for task completion. The Planning Board phase of the project is a novel way to facilitate the often-neglected (and dreaded) task of organizing the manner in which the research is to be conducted. This preliminary step sets the foundation for the writing project by facilitating the selection of relevant topics in a manner that is comfortable to the writer. The topics entered in this phase are identified by color for easy visual identification and this color-coding of topics is carried throughout the remaining phases of the project until completion. The Planning Board also allows the writer to select the type of outline to use.

Research Module 2940

FIG. 6 shows one example of the initial screen for the research card collection step. Note the three sections along the top of the screen: “Sources,” “Content,” and “My Ideas.” These tabs are for collecting and displaying the main components that will become the body of the writing project. One with knowledge in the art will appreciate that the sections are not necessarily restricted to these three and that other sections can be added or combined as appropriate for the writing project.

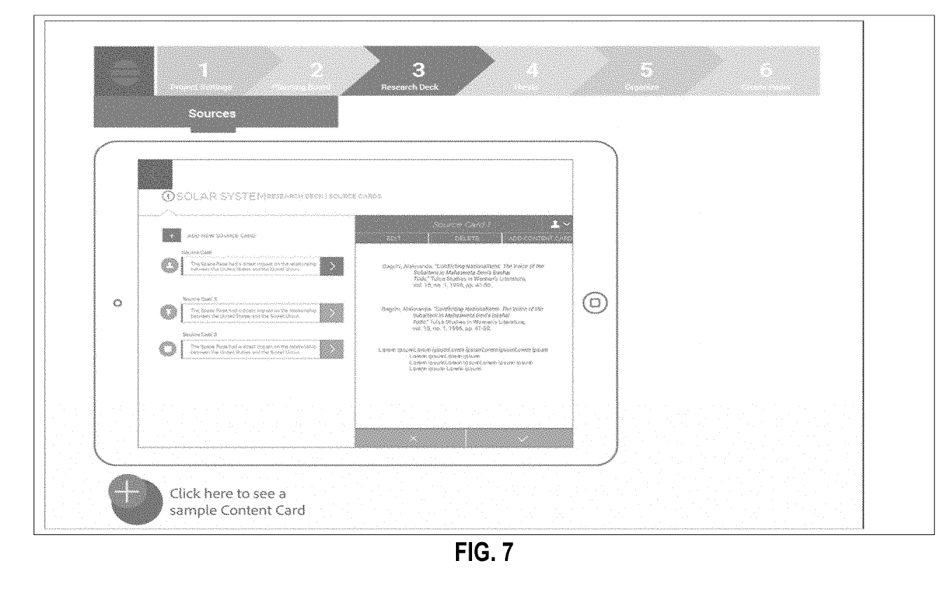

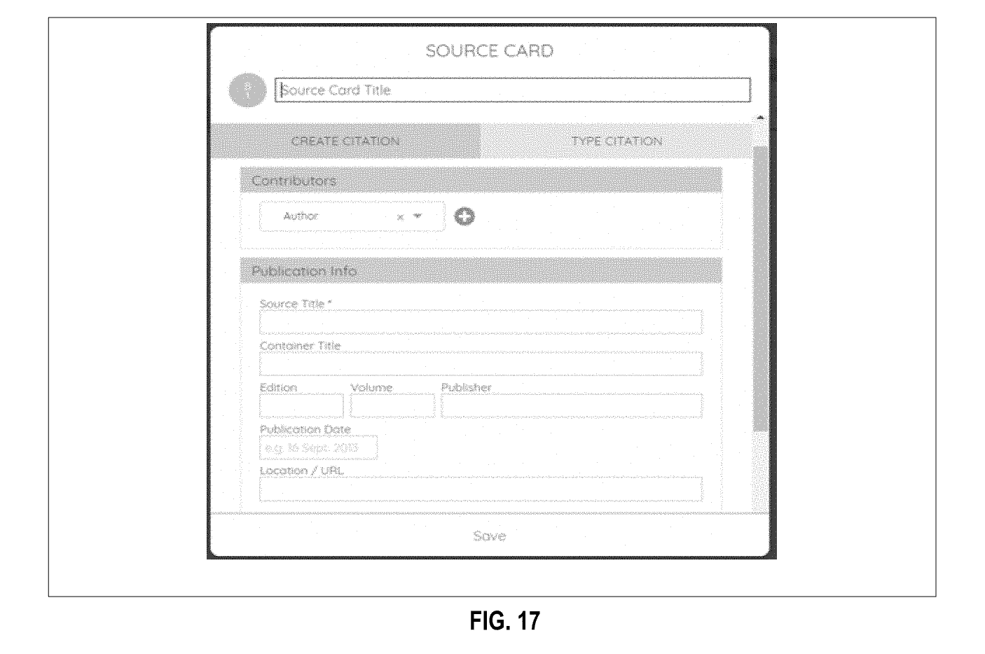

FIG. 7 shows the screen after the writer has selected the “Sources” section from the previous page. This screen is called the “Source List.” Here the writer's previously-entered sources are displayed and new digital source cards may be added. See FIG. 17 for an example of a digital source, or reference, card. The source card features a numbering system to aid the user in tracking the sources. The user completes the fields in the digital source card to create a citation.

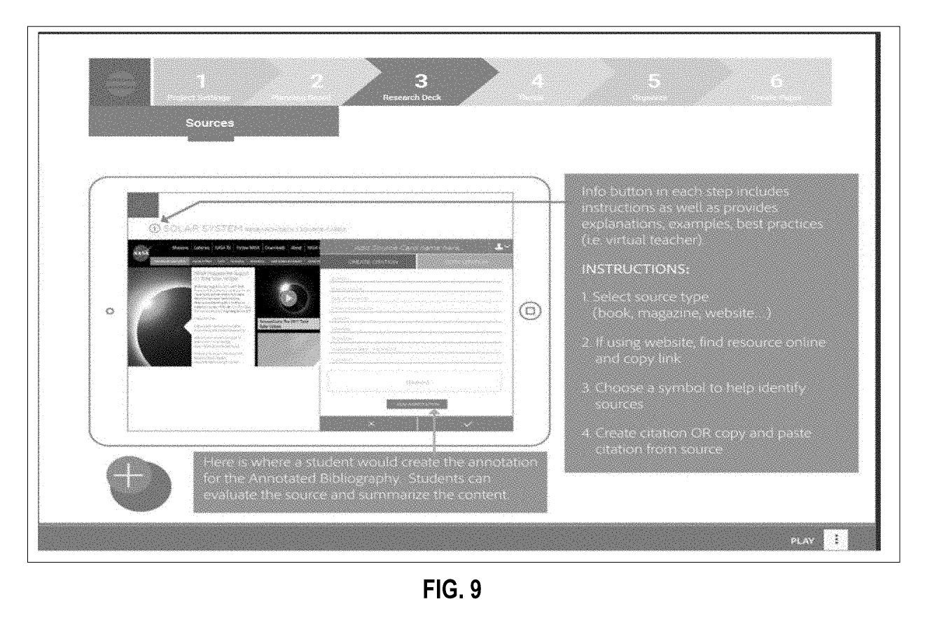

The writer is able to export a source card. One click produces the pre-set citation style. The entered source cards can be deleted or edited on this page. Sources can also be assigned rankings or priorities. For example, in listing reference sources for a medical paper, the Physician's Desk Reference can be assigned a higher priority than, for example, WebMD. FIG. 9 shows an exemplary detailed source selection screen, describing the information help button and the annotated bibliography button.

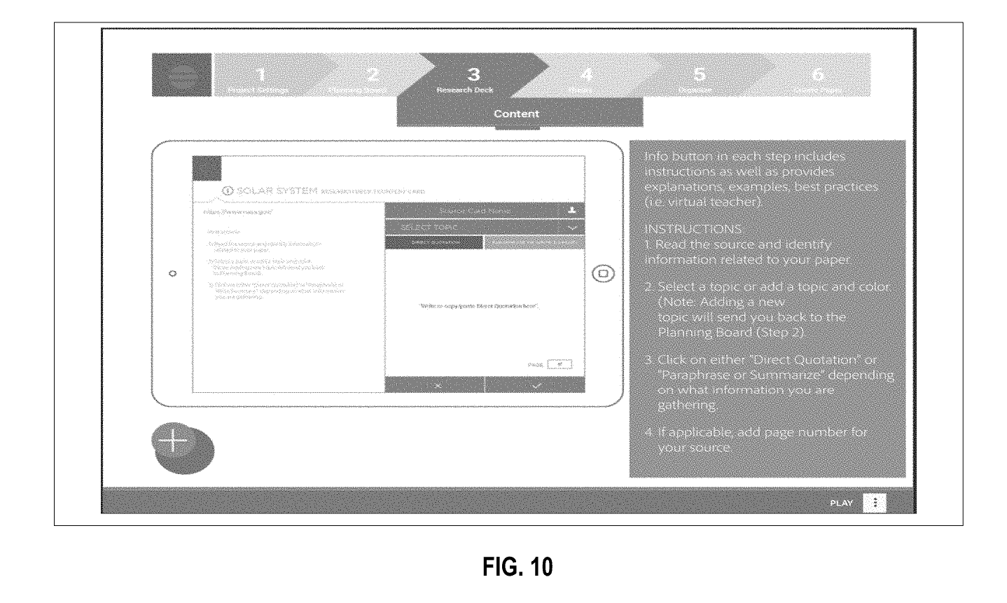

In addition, content cards can be added directly from this page in association with the selected source card. In an embodiment as shown in FIG. 10, an exemplary content card contains: 1) the topic (color-coded); 2) the symbol (representing the source); and 3) the page where it was found. In the content card, the user can either use the direct quotation tab to quote directly from the source or the paraphrase tab to summarize the source. The last field is the in-text citation field that the user completes using the help button. The source cards can be imported into other papers in separate folders. This is possible because of the global data repository, described above.

The only required field in the content card is that a color-coded planning idea must be selected. This is in order to keep the user on track when sifting through large amounts of content. The other option is to return to the planning board to add a new idea to the list. Then the new idea will appear on the dropdown menu. In addition, the content card features a field for in-text citations. The user can use the Info button to help them build the in-text citation field. The software will automatically embed the in-text citation before the corresponding punctuation mark in Step 6 (Draft Paper).

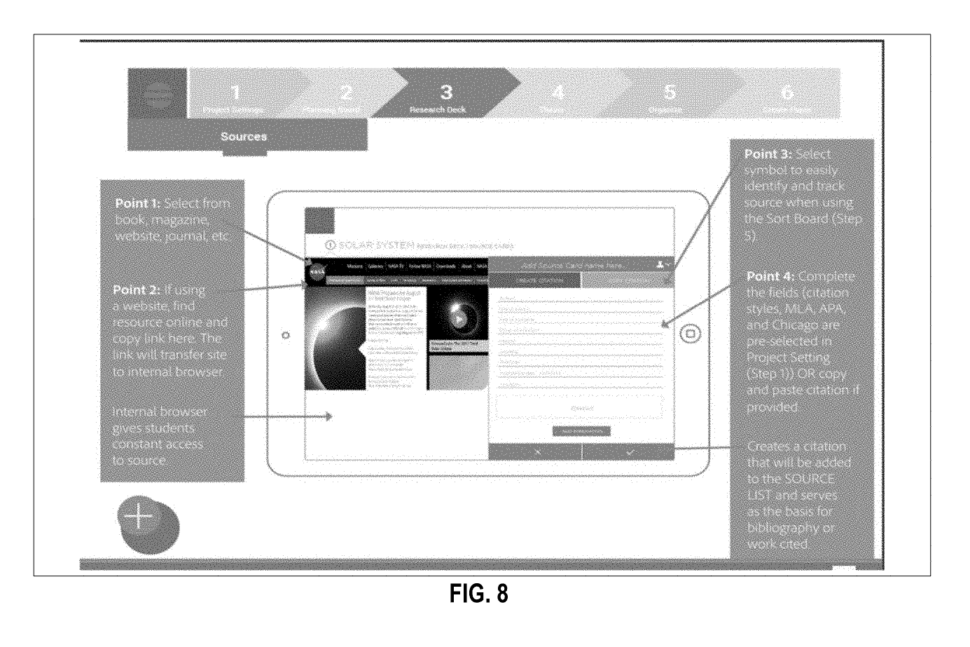

A spell-check feature is integrated with the writing/research tool All research cards are associated with a topic and feature a unique identifier such as a number, an icon, symbol or logo. FIG. 8 shows a sample input screen where the writer is able to enter the information for the source card in an easy-to-follow format. After selecting the source (book, magazine, website, journal, etc.), the writer selects a symbol or icon to represent the source. Using the symbol lets the writer easily identify and track the specific source throughout the writing process. Referring now to FIG. 9, there is shown an option to add an annotated bibliography. Also shown is an example Info button provided in each step of the process. The Info button includes instructions as well as providing explanations, helpful hints, examples, and best practices.

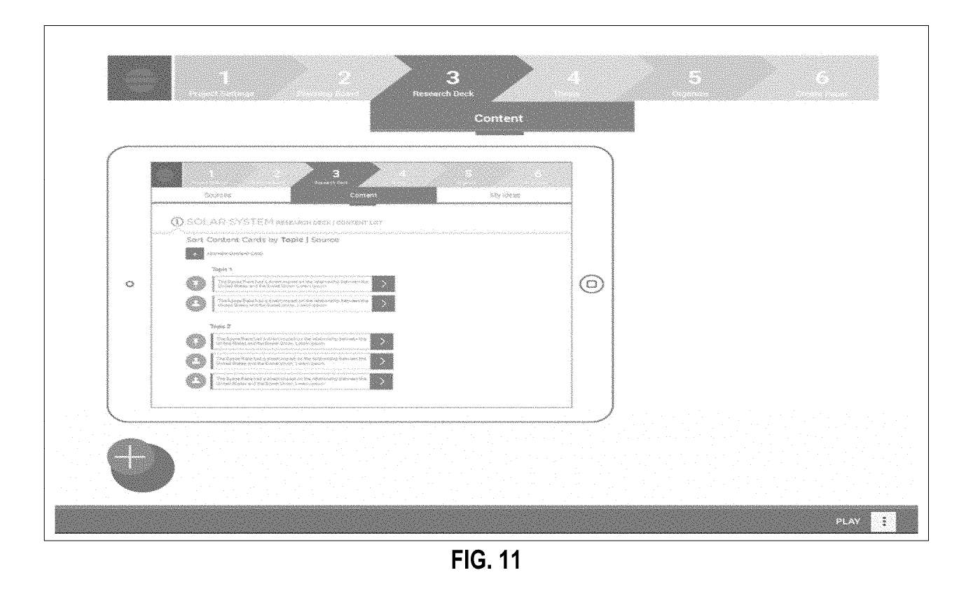

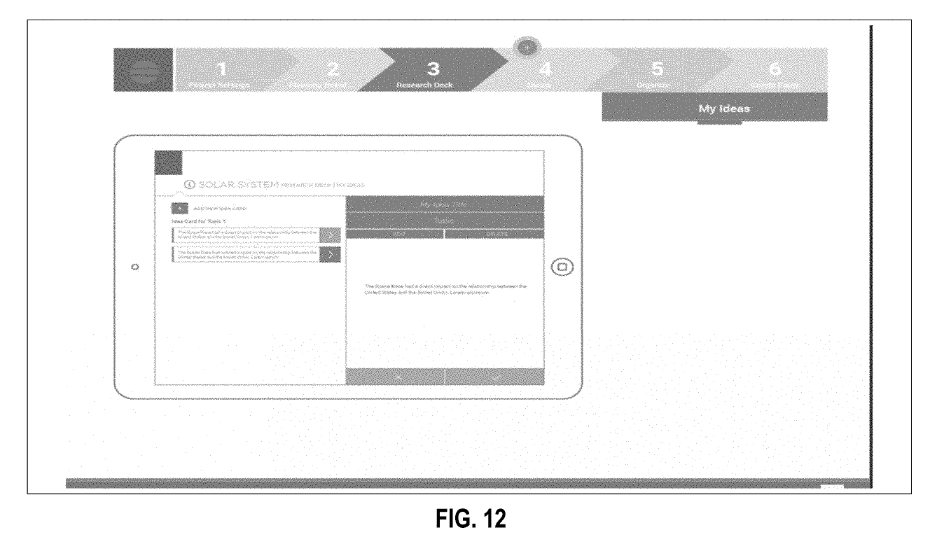

FIG. 10 shows an exemplary screen for selection of the “Content” tab. In this screen the writer is able to enter a content card to be associated with a topic (or sub-topic). Each content card is also associated with a source card. FIG. 11 shows a display of content cards by topic and source. FIG. 12 shows an exemplary screen for selection of the “My Ideas” tab. Here the writer is able to enter ideas that are the writer's own, i.e., not emanating from a particular source. The ideas are, however, associated with a topic. My Idea cards (also called transition cards) ideally should contain transition sentences and include analysis, reflection, and counterpoints. Ideally, transition cards should be written in full sentences in the correct tense.

Requiring these small, measured doses of user input at the beginning of the project addresses a common problem—writer's block—the fear of staring at a blank page without knowing what to write. After completion of this step, the writer proceeds to the next step. The tool allows the writer to toggle back to this module to enter more research cards as the project continues.

Thesis Module 2950

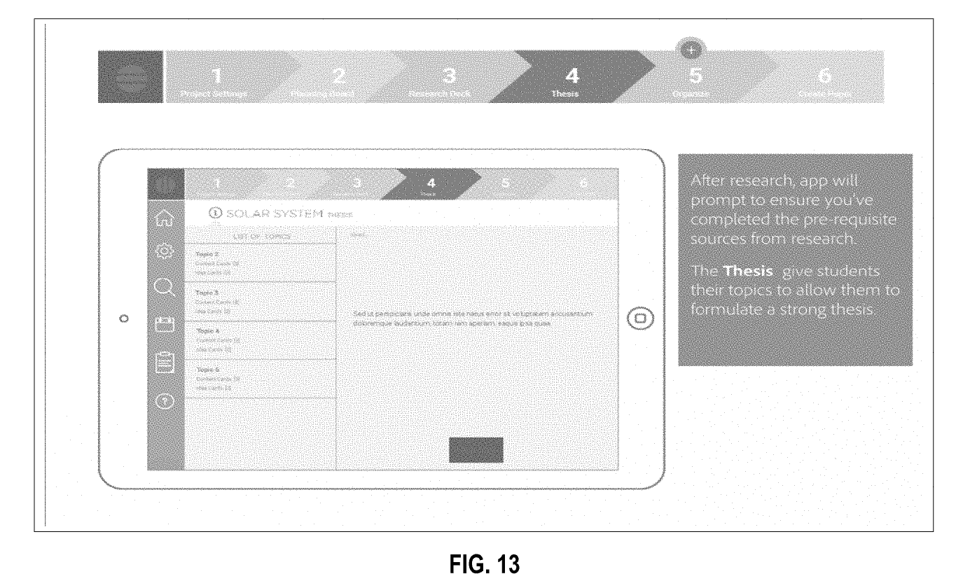

FIG. 13 shows the initial screen for entering the thesis step of the writing process. After conducting the research, the writer is prompted to enter his/her thesis. The writer's selected topics (planning ideas) are displayed. In this phase of the process, the writer's sources are verified. The sources are verified against the paper requirements as provided in the Project Settings Module 2920.

Organization Board Module 2960

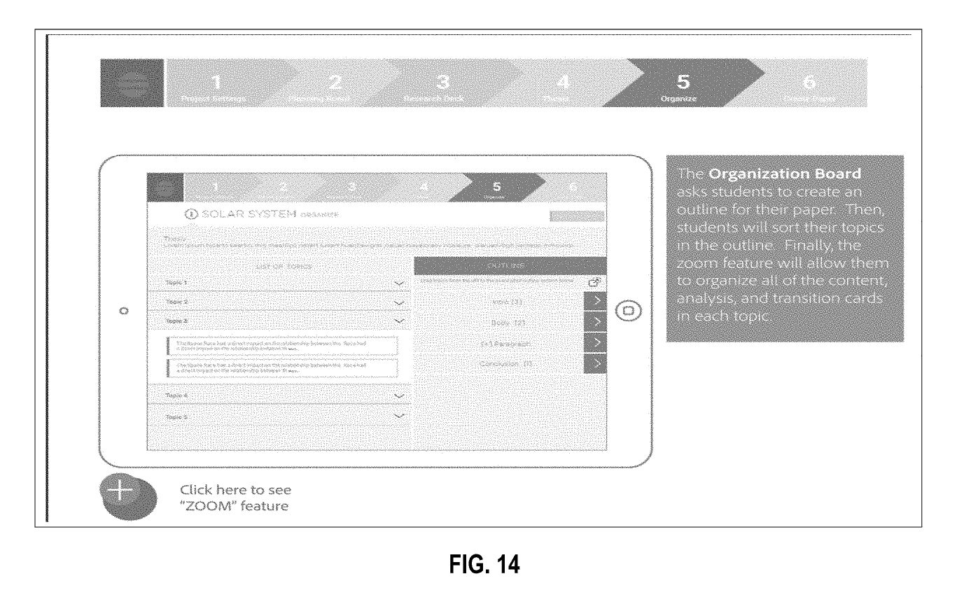

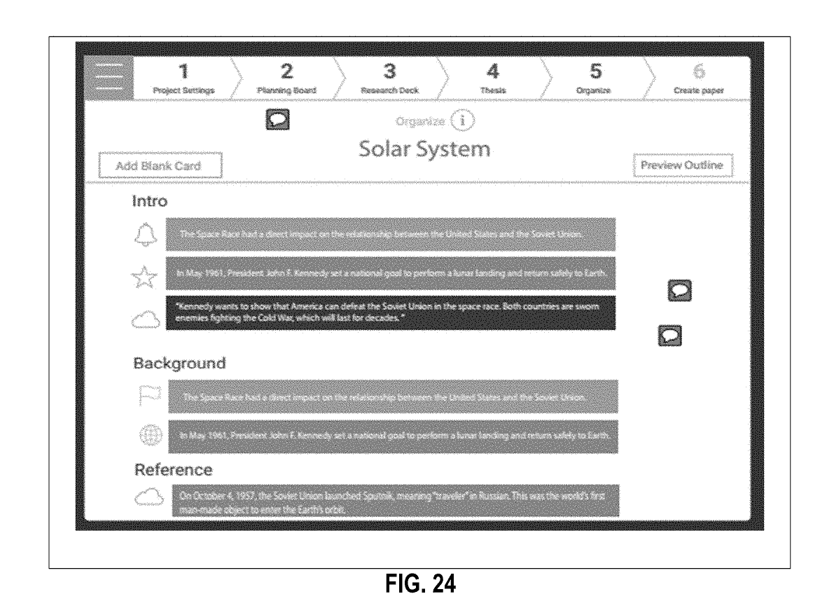

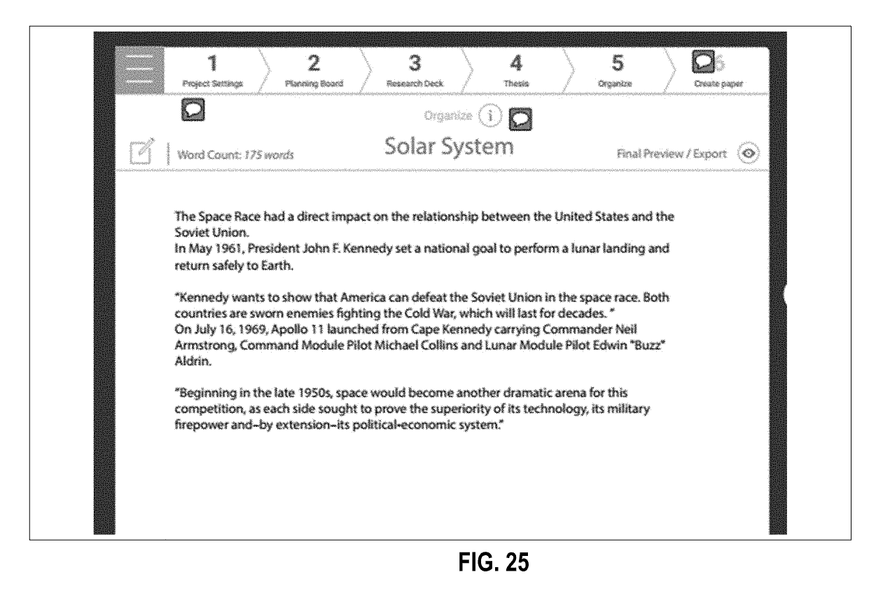

FIG. 14 shows an exemplary screen after selection of the “Organize” tab. A new card, either source/content or my idea can also be added from this screen. The thesis is displayed, as well as a filtered list of topics and sources. Here the topics are displayed in a drop-down menu. The topics are shown with a visual indicator of their tagged sources. The topics can be organized by the writer using the zoom feature shown in FIG. 24. Topics are color-coded to provide visual cues. This makes it easier for the writer to gauge the relative strength of certain topics with regard to other topics. This also provides an easy way for the writer to gauge the strength of his/her arguments. For example, if one color (topic) is associated with one large group of sources, this can mean that too many arguments/topics have been provided by this one source. For example, an abundance of topics tagged with the source “Wikipedia” may be a red flag that your argument is weak or perhaps diluted. In this module the writer is able to change the order of the topics by known means such as dragging and dropping. The topics can also be easily inserted into the appropriate sections of the outline.

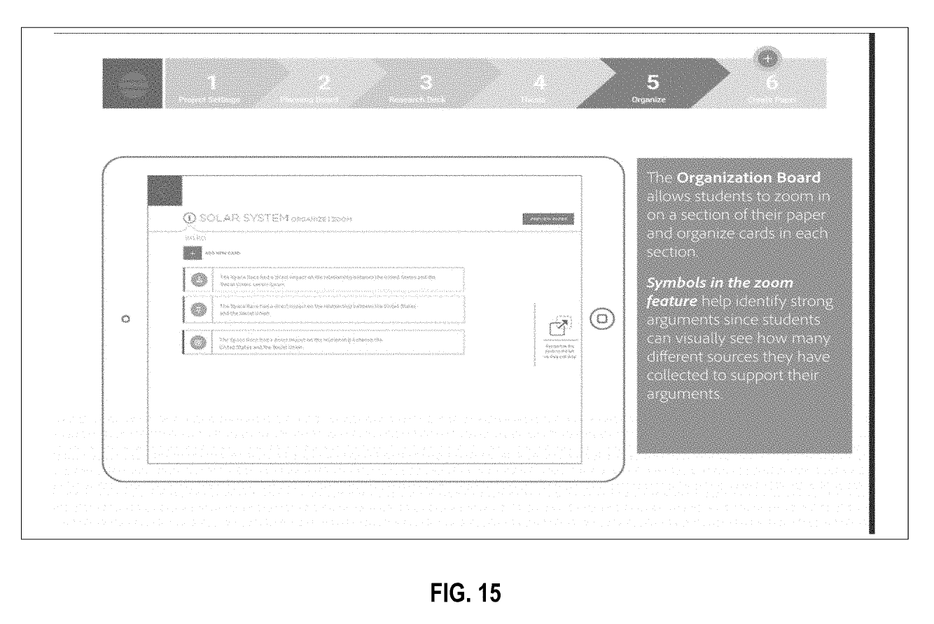

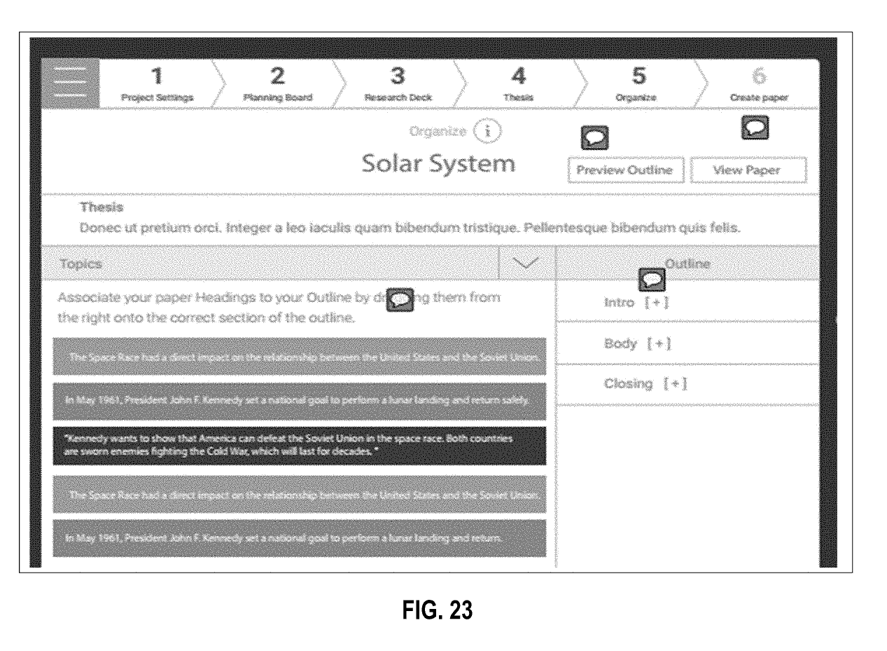

An outline tool is provided with sections for an introduction, body, and conclusion. Note that the outline sections can be modified to suit the requirements of the particular writing project. A zoom feature allows the writer to organize all of the research cards in each topic. FIG. 23 shows the screen before a drag and drop is performed. FIG. 15 and FIG. 24 both show the zoom feature. FIG. 14 shows that the topic counter in the outline (body) has increased since the topics were dragged into the outline. The writer is able to zoom in on a section of the document and organize the cards for that section. Symbols/icons associated with the sources help identify strong arguments since writers can easily see how many different sources have been collected to support a particular topic/argument. The topics can be moved up or down to change the presentation order.

All research cards are associated with a source or reference, designated by a user-selected image or icon. In this phase of the process, the research cards are filtered by icon (source identifier) within each color-coded topic. Content cards are automatically associated with their source cards by virtue of their assigned identifier (icon). The method of association is performed in a background process and can include, for example, embedding tags. Therefore, we can say that a content card is automatically “tagged” with its associated source card.

Draft Paper Module 2970

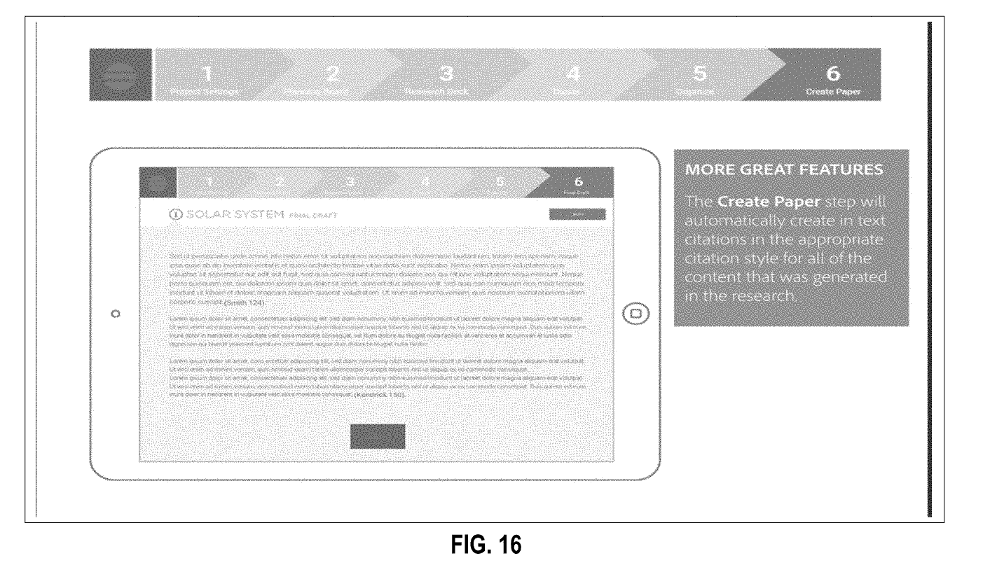

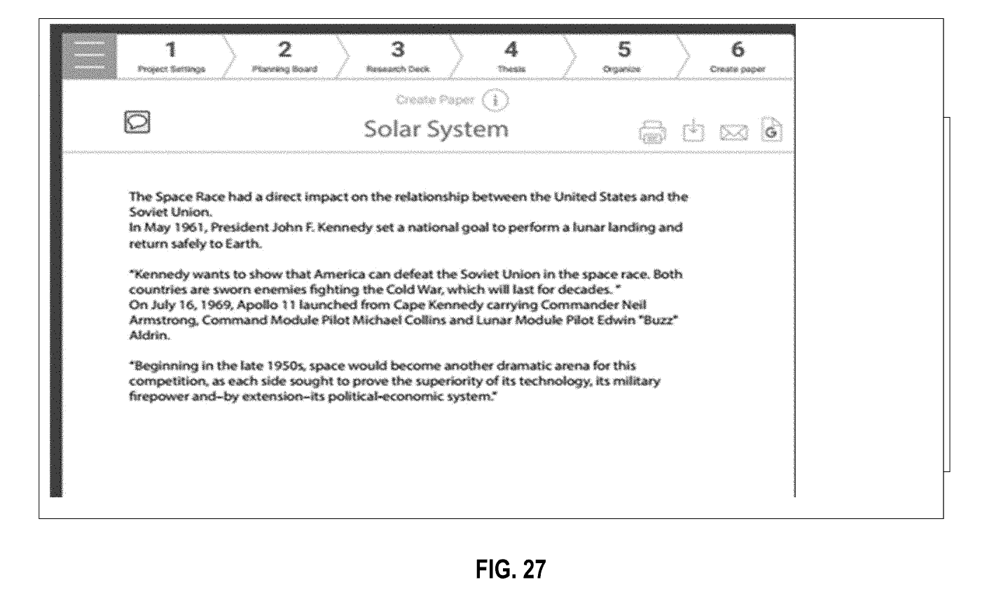

FIG. 16 shows an exemplary screen displaying the resulting document in an editable format. The output document is, for example, an electronic document such as a PDF, RTF, or other document format readable by a word processing program. In this step, the Draft Paper Module 2970 issues instructions for the computer processor to access the data structures generated by the other modules, read the inputs from those data structures, and, according to the instructions associated with those data structures, transform those inputs into an editable document 2990 with citations in the appropriate citation style as selected in the Project Setting Module 2920 and for the content that was generated and input into the Research Module 2940. FIG. 27 shows another example screen featuring options for sharing/downloading/printing the document. In a wholly automated process, the Draft Paper Module 2970 generates a new data structure in the form of an editable document 2990 by rendering the content and “My Ideas” transition cards, in the order as provided by the outline from the Organize Module 2960, along with their tagged source cards presented as in-text citations, in one example. The citations are automatically formatted by applying the citation style rules set by the user. The entire process of generating the document is not tied to a single user but can be shared among a group of writers in a collaborative setting, such as a Net Meeting.

In another embodiment, instead of presenting the completed research paper, the Draft Paper module features a blank screen so that the writer can write the document using the sorted/organized research cards in the selected outline format. This feature can be selectively enabled/disabled by an administrator such as a teacher.

Although digital writing tools exist, no other tool provides a systematic approach to building a research paper. No other tool automatically generates citations and includes them in the paper. Assigning a unique identifier (icon) to the source cards in association with the color-coded topics (planning ideas) enables a novel approach to writing a correctly formatted research paper.

Monetization

The writing/research tool can be provided on a subscription basis. For example, a yearly subscription fee can be collected per student, per school, etc. The tool can also be provided as a mobile application download for a one-time or subscription fee. The tool can be customized such that one software package is offered at a basic level for individual sale while another software package includes built-in controls and a collaborative feature for enterprise and/or academic use. The writing/research tool can be licensed as a single-use license and/or multi-user license, such as for schools. The writing/research tool is of particular benefit to students, helping them to: a) focus on content and analysis; b) organize and streamline ideas; c) avoid plagiarism; d) reduce citation errors; and e) work faster with less stress.

The writing/research tool, in one example, tracks the standards of the Common Core Standards Initiative. 42 out of 50 U.S. States have adopted the Common Core State Standards Initiative establishing guidelines for educational achievement for kindergarten through 12^{th} grade. The writing/research tool can be tied to other standards or protocols as well. In addition, the writing/research tool can interface with Internet-enabled tools such as plagiarism detection software which can automatically scan and check entered content.

Hardware Embodiment

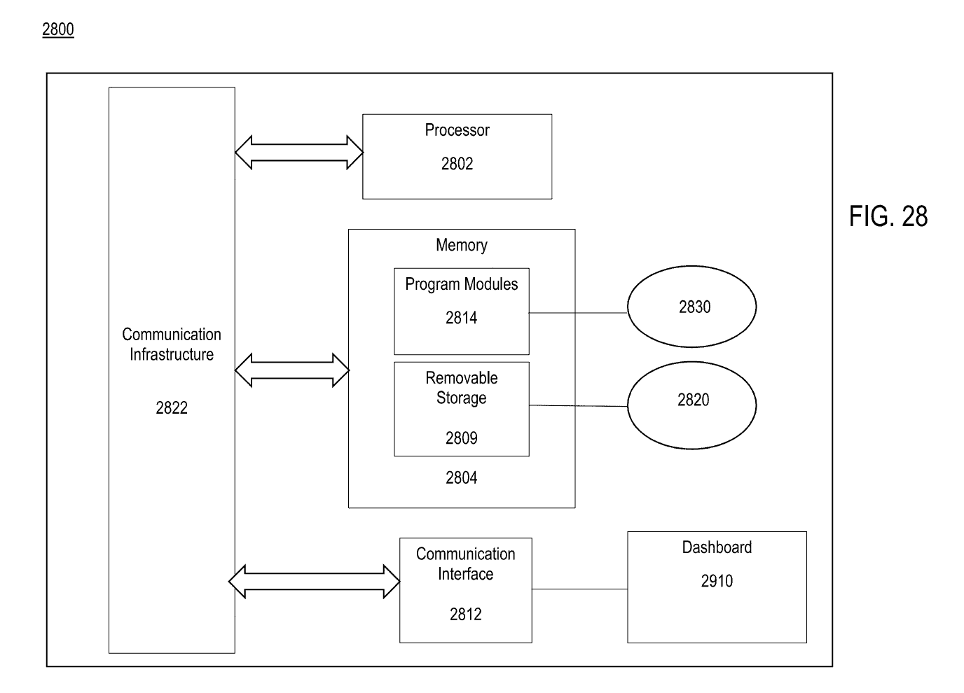

FIG. 28 illustrates a simplified block diagram of an exemplary writing/research system 2800, according to an embodiment of the present invention. The system shown in FIG. 28 is only one example of a suitable system and is not intended to limit the scope of use or functionality of embodiments of the present invention described above. The system adds functionality to, and provides a technical improvement to, the computing system environment. Examples of well-known computing systems, environments, and/or configurations that may be suitable for use with the information processing system include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, clusters, and distributed cloud computing environments that include any of the above systems or devices, and the like.

The system 2800 may be described in the general context of computer-executable instructions, being executed by a computer system. The system 2800 may be practiced in various computing environments such as conventional and distributed computing environments where tasks are performed by remote processing devices that are linked through a communications network. In a distributed computing environment, program modules may be located in both local and remote computer system storage media including memory storage devices.

Referring again to FIG. 28, the system 2800 includes a graphical user interface in the form of a dashboard 2910. Other components of the computer system can include, but are not limited to, one or more processor devices 2802 or processing units, a system memory 2804, and a bus 2822 that couples various system components including the system memory 2804 to the processor 2802. One with knowledge in the art can appreciate that many other computer components make up today's modern computer systems. These are not shown here in order to simplify the presentation and not obscure the claimed features of the disclosure.

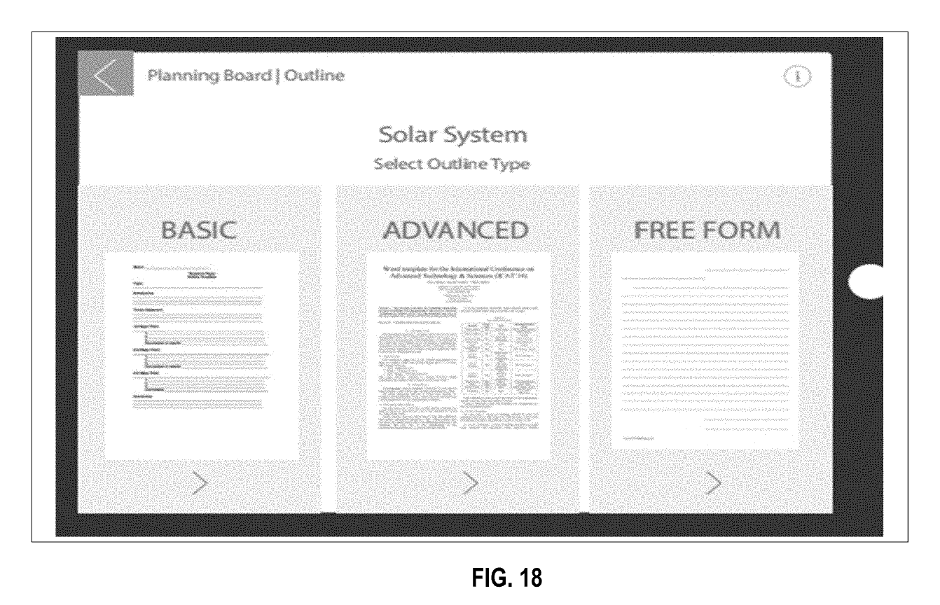

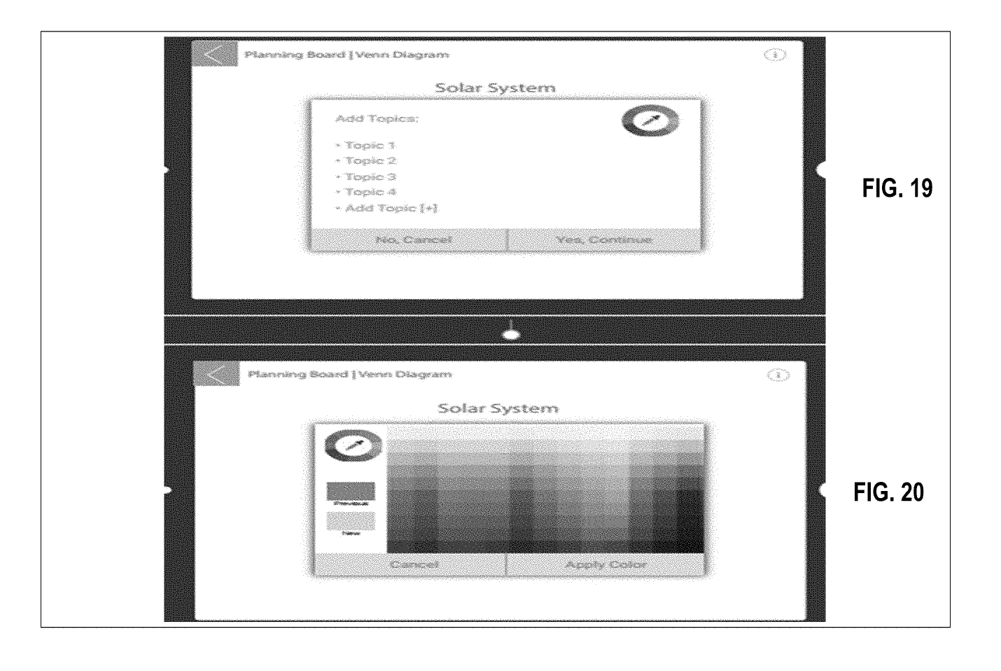

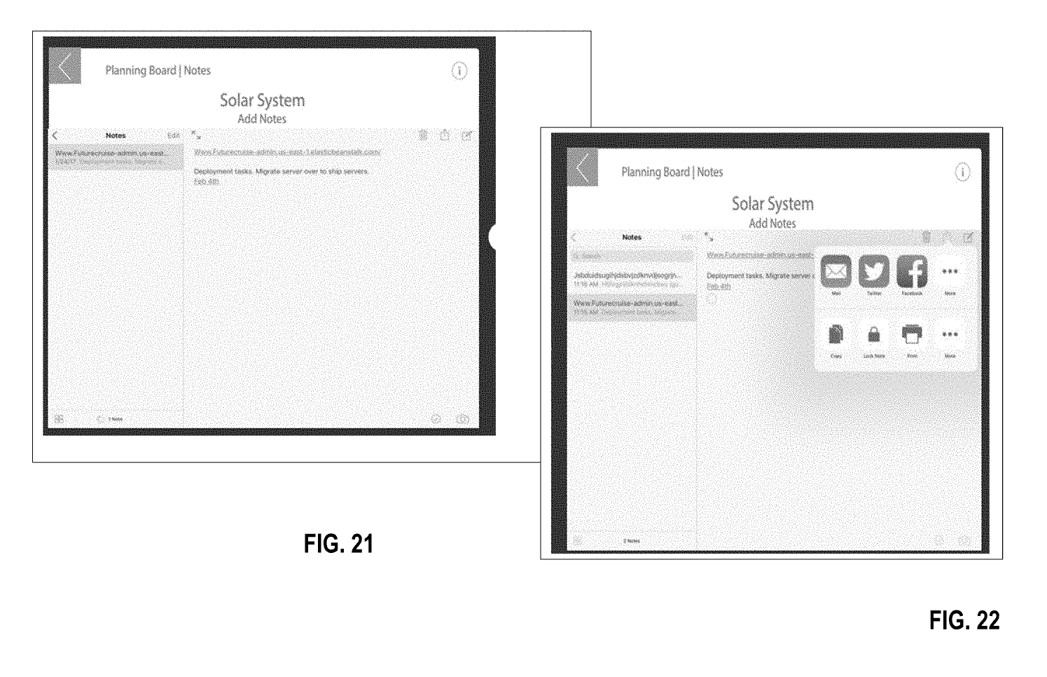

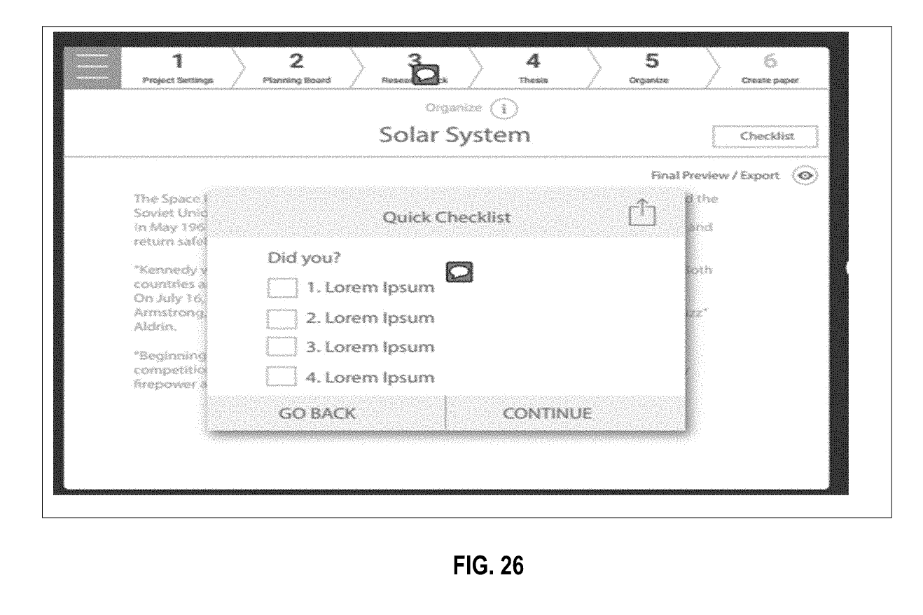

The system memory 2804 can also include computer system readable media in the form of volatile memory, such as random access memory (RAM) and/or cache memory. By way of example only, a storage system can be provided for reading from and writing to a non-removable or removable, non-volatile media such as one or more solid state disks and/or magnetic media (typically called a “hard drive”). The memory can include at least one program product embodying a set of program modules that are configured to carry out one or more features and/or functions of the present invention e.g., described with reference to FIGS. 1-27. A global data repository 2830 can be used to store data for accessibility across folders (projects). The global data repository 2830 can store data locally or remotely.

Referring again to FIG. 28, a set of program modules 2814 may be stored in memory by way of example, and not limitation, as well as an operating system, one or more application programs, other program modules, and program data. Generally, program modules may include routines, functions, programs, objects, components, logic, data structures, and so on that perform particular tasks or implement particular abstract data types. Each of the operating system, one or more application programs, other program modules, and program data or some combination thereof, may include an implementation of a networking environment. In some embodiments, program modules such as the modules described above are configured to carry out one or more functions and/or methodologies of embodiments of the present invention. The program modules can themselves incorporate other sub-modules. For example, the Organize Module can incorporate an Outline Module.

The system can also communicate with one or more external devices that enable interaction with the dashboard 2910; and/or any devices (e.g., network card, modem, etc.) that enable communication with one or more other computing devices. A few (non-limiting) examples of such devices include: a keyboard, a pointing device, a display, and/or any devices (e.g., network card, modem, etc.) that enable the system to communicate with one or more other computing devices. Such communication can occur via I/O interfaces. In some embodiments, the system can communicate with one or more networks such as a local area network (LAN), a general wide area network (WAN), and/or a public network (e.g., the Internet) via network adapter. Other hardware and/or software components can also be used in conjunction with the system. Examples include, but are not limited to: microcode, device drivers, redundant processing units, external disk drive arrays, RAID systems, tape drives, and data archival storage systems.

As will be appreciated by one skilled in the art, aspects of the present invention may be embodied as a system, method, or computer program product at any possible technical detail level of integration. The computer program product may include a computer readable storage medium (or media) having computer readable program instructions thereon for causing a processor to carry out aspects of the present invention.

The computer readable storage medium 2820 can be a tangible device that can retain and store instructions for use by an instruction execution device. The computer readable storage medium 2820 may be, for example, but is not limited to, an electronic storage device, a magnetic storage device, an optical storage device, an electromagnetic storage device, a semiconductor storage device, or any suitable combination of the foregoing. A computer readable storage medium 2820, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium 2820 within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuit or either source code or object code written in any combination of one or more programming languages, including an object oriented programming language and procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) (In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention have been discussed above with reference to block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor device 2802 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a non-transitory computer readable storage medium 2820 that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as welt unless the context clearly indicates otherwise. It will be further understood that the terms “comprises” and/or “comprising,” when used in this specification, specify the presence of stated features, integers, steps, operations, elements, and/or components, although do not preclude the presence or addition of one or more other features, integers, steps, operations, elements, components, and/or groups thereof.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand various embodiments of the present invention, with various modifications as are suited to the particular use contemplated. It is to be understood that features from one embodiment can be implemented with other embodiments.

1. A computer-implemented method for assisting a writer in organizing and writing a paper with citations, the computer-implemented method comprising:
providing a graphical user interface through which the writer interacts with a plurality of modules configured to generate the paper with automatically applied citations;
providing a project setting module for selection of a title and a documentation style;
providing a planning module for:
selection of a project planning format;
selection of research topics;
formatting the research topics according to the project planning format; and
assigning color identifiers to the research topics;
providing a research module for providing digital research cards comprising:
a digital reference card for each reference provided by the writer, wherein each reference is assigned a unique identifier and formatted in the selected documentation style;
a digital content card for receiving content derived from a specific reference, each digital content card color-coded by research topic and associated with the specific reference by a unique identifier; and
a digital transition card for transitional sentences provided by the writer, each digital transition card color-coded by the research topic;
providing a thesis module through which the writer provides a thesis;
providing an organize module with an outline tool for:
sorting the digital research cards by associated reference within each color-coded topic;
organizing the sorted digital research cards according to a pre-selected outline format;
presenting an outline with the organized, sorted digital research cards; and
providing a feature allowing the writer to re-arrange the organized, sorted digital research cards in the outline; and
providing a draft paper module for rendering the digital content cards and the digital transition cards, in the order as provided in the outline, as an editable document with associated references presented as in-text citations in the selected documentation style.

2. The computer-implemented method of claim 1 wherein providing the graphical user interface further comprises restricting interaction with the plurality of modules such that the writer must successfully complete one module before interacting with another module.

3. The computer-implemented method of claim 1 wherein the project setting module implements a calendar function allowing the writer to enter project due dates and schedule reminders.

4. The computer-implemented method of claim 1 wherein the planning module presents a visual indicator of a status of project completion.

5. The computer-implemented method of claim 1 wherein the research module ranks the references.

6. The computer-implemented method of claim 1 further comprising implementing a zoom feature.

7. The computer-implemented method of claim 1 further comprising implementing a drag and drop feature.

8. The computer-implemented method of claim 1 wherein the research module associates the digital content card with the specific reference by embedding a tag.

9. A computer-implemented system for assisting a writer in organizing and writing a paper with citations, the computer-implemented system comprising:
a processor device;
a memory operatively coupled with the processor device;
a graphical user interface through which the writer interacts with a plurality of modules configured to generate the paper with automatically applied citations; and
the plurality of modules comprising:
a project setting module configured for selection of a title and a documentation style;
a planning module configured for:
selection of a project planning format;
selection of research topics;
formatting the research topics according to the project planning format; and
assigning color identifiers to the research topics;
a research module configured for providing digital research cards comprising:
a digital reference card for each reference provided by the writer, wherein each reference is assigned a unique identifier and formatted in the selected documentation style;
a digital content card for receiving content derived from a specific reference, each digital content card color-coded by research topic and associated with a specific reference by a unique identifier; and
a digital transition card for receiving transitional sentences from the writer, each digital transition card color-coded by the research topic;
a thesis module through which the writer provides a thesis;
an organize module with an outline tool configured for:
sorting the digital research cards by associated reference within each color-coded topic;
organizing the sorted digital research cards according to a pre-selected outline format;
presenting an outline with the organized, sorted digital research cards; and
providing a feature allowing the writer to re-arrange the digital research cards in the outline;
a draft paper module configured for rendering the digital content cards and the digital transition cards, in the order as provided by the pre-selected outline format, as an editable document with associated references presented as in-text citations in the selected documentation style.

10. The computer-implemented system of claim 9 wherein the project setting module further comprises a calendar function allowing the writer to enter project due dates and schedule reminders.

11. The computer-implemented system of claim 9 wherein the graphical user interface is a dashboard interface.

12. The computer-implemented system of claim 9 wherein the graphical user interface comprises selectable icons that, when selected, provide access to examples and instructions.

13. The computer-implemented system of claim 9 further comprising a global data repository storing digital files from one writing project that can be accessed by another writing project.

14. The computer-implemented system of claim 9 wherein the project settings module is further configured to accept paper requirements.

15. The computer-implemented system of claim 14 wherein the thesis module is further configured to verify the references against the paper requirements entered in the project settings module.

16. The computer-implemented system of claim 9 wherein the research module is further configured to associate the specific reference to the digital content card by embedding a tag.

17. The computer-implemented system of claim 9 wherein the project planning format is a bulleted list.

18. The computer-implemented system of claim 9 wherein the project planning format is a Venn diagram.

19. The computer-implemented system of claim 9 further comprising a zoom feature.

20. The computer-implemented system of claim 9 further comprising a drag and drop feature.
